(19) United States
(12) Patent Application Publication
(10) Pub. No.: US 2009/0228441 A1
(43) Pub. Date: Sep. 10, 2009

(54) COLLABORATIVE INTERNET IMAGE-SEARCHING TECHNIQUES

(76) Inventor: Bjornar Sandvik, Mountain View, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/044,885

(22) Filed: Mar. 7, 2008

(51) Int. Cl. G06F 17/30

(52) U.S. Cl. 707/3; 707/E17.108

(57) ABSTRACT

Users in an Internet user community are enabled to collaboratively attach user-submitted comments and answers to images that other users in the community have provided. These comments and answers are searchable by other users who are searching for images that might be attached to those comments and answers. A server receives an image and a question from a particular user. The server dynamically generates, for another user, a “gallery” web page that contains the image that the particular user uploaded. When the other user clicks on the image that the particular user uploaded, the server generates an image-specific web page dynamically for the other user. The image-specific web page includes comments that yet other users have created and uploaded to the server after viewing the image-specific web page. These comments may include answers to the particular user's uploaded question, and/or other user-generated commentary pertaining to the subject of the image.

### FIELD OF THE INVENTION

The present invention relates to search engines, and, more specifically, to techniques for searching for images that are accessible via the Internet.

### BACKGROUND

An abundance of information is available via the Internet. Users can direct web browser applications, such as Mozilla Firefox, to various Uniform Resource Locators (URLs) in order to view content that is associated with those URLs. In order to assist users in locating certain kinds of content for which the users do not know the associated URLs, various Internet search engines have emerged. Yahoo! is the owner and operator of one of these Internet search engines.

A user can enter a set of query terms into an Internet search engine's user interface. The Internet search engine receives the query terms and searches an index for known content items that are associated with the query terms. The Internet search engine creates a list of content items that are relevant to the submitted query terms. The Internet search engine returns the list to the user.

When the first Internet search engines emerged, the results returned by the search engines were hyperlinks to web pages that those search engines deemed to be relevant to the user-supplied query terms. Typically, a web page that contained the query terms was deemed to be relevant. Along with those hyperlinks, some search engines returned abstracts or blurbs that gave the query term-submitting user a hint as to the content of the page, and the context in which the query terms were used in the page. The abstracts were entirely textual, however.

Later, more advanced Internet search engines allowed a user to indicate that the search was to be performed specifically relative to images that were available on the Internet. These search engines indexed the images that they found (via web crawling) on the Internet. In the index, the images were associated with the words that were also on the web pages on which the images were found. A user who wanted to search for images pertaining to a certain phrase could supply that phrase as a set of query terms to the search engine, and instruct the search engine to return images. In other words, the user would instruct the search engine to search the “image vertical”—a subset of the entire Internet-rather than the Internet generally. In response, the search engine would determine which of the indexed web pages contained the user-submitted query terms, and return a set of images that were located on those web pages. Unfortunately, because the images on a web page often did not have any significant correlation with most (or even any) of the words on that web page, the images returned by the search engine often bore little relevance to the user-submitted query terms, even when the web pages containing those images actually contained one or more of those query terms.

Thus, a user who wants to find an image of a specific subject on the Internet often will be frustrated that the existing approaches for finding images on the Internet return image results that are largely different than what the user was looking for. Additionally, because current approaches require a user to choose words to describe the images in which the user is interested, the user's frustration is likely to be compounded under circumstances in which the user cannot formulate an accurate verbal description of those images. A user might not be able to formulate an accurate verbal description of an image because, although the user might have a good idea of the visual appearance of the subject in which he is interested, the user might have an incorrect perception of what that subject is called; indeed, the user might not have any idea as to what words correctly describe the subject about which the user wants to search for images. In some cases, the user might have seen a subject that was entirely unknown to the user. The whole reason that the user wants to search the Internet might be to identify the subject that the user saw, but cannot describe in verbal terms.

Thus, a major shortcoming of image-searching approaches used by current Internet search engines is that those search engines virtually require a user to possess a correct verbal description of a subject before the user can even begin to search for images that feature that subject.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Various embodiments of the present invention are illustrated by way of example, and not by way of limitation, in the figures of the accompanying drawings and in which like reference numerals refer to similar elements and in which:

FIG. 1 is a block diagram that illustrates an example of a system in which embodiments of the invention may be implemented and practiced;

FIG. 2 is a block diagram that illustrates an example of a gallery web page that a server may serve to an Internet browser, according to an embodiment of the invention;

FIG. 3 is a block diagram that illustrates an example of an image-specific web page that a server may serve to an Internet browser, according to an embodiment of the invention;

FIG. 4 is a block diagram that illustrates an example of a search results web page that a server may serve to an Internet browser, according to an embodiment of the invention; and

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to techniques described herein, users in an Internet user community are enabled to collaboratively attach user-submitted comments and answers to images that other users in the community have provided. These comments and answers are searchable by other users who are searching for images that might be attached to those comments and answers. While some approaches for searching for images involve a user supplying keywords to a search engine and receiving images in return, certain techniques disclosed herein involve a user supplying an image to a server in hopes that other users in the community will provide descriptive keywords in return.

According to one such technique, a server, accessible to a particular user's Internet browser via the Internet, receives an image that the particular user uploads to the server over the Internet. The server responsively stores the image. The particular user who uploaded the image might not even know what the subject of the image is. Along with the image, the user may upload a question that pertains to the image. Under such circumstances, the server may store the uploaded question in association with the uploaded image.

When another user later directs his Internet browser to a particular URL on the server, the server dynamically generates a “gallery” web page that contains, among potentially many different images that many different users have uploaded to the server, the image that the particular user uploaded. The image might be a reduced-size “thumbnail” version of the originally uploaded image. The server sends the dynamically generated gallery web page to the browser of the other user. Each of the images in the gallery web page may be associated with a separate link that directs an Internet browser to a different image-specific web page generated by the server-a different image-specific web page for each image in the gallery.

When the other user clicks or otherwise selects the image that the particular user uploaded, the other user's Internet browser requests, from the server, the image-specific web page that corresponds to the image. The server generates this image-specific web page dynamically and sends the image-specific web page to the other user's Internet browser. In addition to the image, the image-specific web page may include comments that yet other users have created and uploaded to the server after viewing the image-specific web page. These comments may include answers to the particular user's uploaded question (if any), and/or other user-generated commentary pertaining to the subject of the image.

After receiving the image-specific web page and viewing the image contained therein, the other user may enter, into a text field on the image-specific web page, a comment of the other user's own creation. For example, if the image-specific web page includes a question that the particular user originally uploaded with the image, then the other user may enter, into the text field, text that the other user thinks is an appropriate answer to the question. After clicking on or otherwise selecting a “submit” control on the image-specific web page, the other user's Internet browser uploads the other user's comment to the server. The server responsively receives the comment and stores the comment in association with the particular image and any other comments that have already been associated with the particular image. Thereafter, when the server generates the image-specific web page, the image-specific web page also includes the other user's comment.

Thus, many different users can submit, via the Internet, comments and answers that pertain to images that other users have uploaded to the server. The server stores these comments and answers in association with the images to which those comments and answers pertain. In addition to the above features, the server may provide, to interested users' Internet browsers, a search web page that contains a field into which those interested users can enter query terms—this field may be contained in the gallery web page discussed above, for example. In response to receiving such query terms, the server locates stored user comments, answers, and questions that contain or are relevant to one or more of the query terms. The server determines a set of images that are associated with these query term-relevant user comments, answers, and questions, and dynamically generates a search results web page that contains the images, or reduced-size thumbnails of the images, in the set of images. In the search results page, each image may be accompanied by the associated comment, question, or answer that contains or is relevant to the query terms. Interested users can click on or otherwise select these images in order to direct their browsers to the image-specific web pages that are associated with those images.

Using the foregoing technique, users in an Internet user community are able to obtain answers to questions about images. Users who are unable to formulate an accurate verbal description of an image can use the foregoing technique to invite other users in the community, who might know more about the image, to submit informed comments about the image. Because user-submitted comments pertain to the images themselves (and are not merely words that happened to be co-located on the same web pages from which images were extracted), users who are searching for images that pertain to a set of query terms are more likely to find images that actually do pertain to those query terms, at least in the views of others in the user community.

Other features that may be included in various different embodiments of the invention are discussed in more detail below.

### Example System

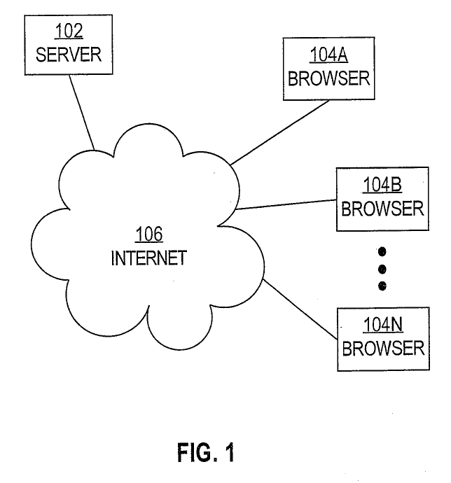

FIG. 1 is a block diagram that illustrates an example of a system in which embodiments of the invention may be implemented and practiced. The system of FIG. 1 comprises a server 102, browsers 104A-N, and Internet 106. Alternative embodiments of the invention may include more, fewer, or different components that those illustrated in FIG. 1.

In one embodiment of the invention, browsers 104A-N execute on separate computers, such as desktop or laptop computers. However, in one embodiment of the invention, one or more of browsers 104A-N executes on a mobile device such as a mobile or cellular telephone. Such a cellular telephone may be equipped with a built-in camera that is capable of taking digital photographs, storing those photographs, and transmitting those photographs to other devices (such as server 102) over Internet 106.

Each of browsers 104A-N communicates with server 102 via Internet 106. For example, browsers 104A-N may send Hypertext Transfer Protocol (HTTP) requests to, and receive HTTP responses from, server 102 across Internet 106. These HTTP requests and responses may be transmitted according to a multi-level suite of network communication protocols, typically including Transfer Control Protocol (TCP) and Internet Protocol (IP). Each of browsers 104A-N may be used by a different user. Browsers 104A-N may be widely distributed over the entire Earth. Using browsers 104A-N, users of browsers 104A-N specify the URL that is associated with a web page (e.g., the gallery web page discussed above) that server 102 stores or dynamically generates. In response to these users specifying the URL, browsers 104A-N request, over Internet 106, from server 102, the web page that is associated with that URL. Server 102 receives these requests and dynamically generates and sends the requested web page to browsers 104A-N over Internet 106 in response.

In one embodiment of the invention, users of browsers 104A-N use browsers 104A-N to upload images to server 102 over Internet 106. Browsers 104A-N may upload these images to server 102 using File Transfer Protocol (FTP), for example. In response to receiving these images, server 102 stores these images on a persistent storage medium such as a hard disk drive. Additionally, in one embodiment of the invention, users of browsers 104A-N use browsers 104A-N to upload questions, answers, and comments that pertain to the images that are stored on server 102. Browsers 104A-N may upload these questions, comments, and answers to server 102 using HTTP, for example. In response to receiving these questions, answers, and comments, server 102 stores these questions, answers, and comments on the persistent storage medium. Server 102 also creates an association, such as a mapping, between the questions, answers, and comments, and the images to which those questions, answers, and comments pertain. Server 102 stores these associations on the persistent storage medium. In one embodiment of the invention, a user uploads, to server 102, from that user's cellular telephone, a digital photograph that the user took using the camera that is built into the user's cellular telephone.

In one embodiment of the invention, the functionality of server 102 is provided instead by multiple separate servers to which the requests of browsers 104A-N are distributed by a load-balancing device that receives those requests. Each such server may access a central repository of data that includes images, questions, answers, and comments that users have submitted.

In one embodiment of the invention, browsers 104A-N upload images, questions, answers, and comments to server 102 via web page forms that are contained in web pages that server 102 serves to browsers 104A-N over Internet 106. Thus, in one embodiment of the invention, server 102 is, or comprises, a web server. Some examples of form-containing web pages that server 102 servers to various ones of browsers 104A-N are discussed in greater detail below.

### Example Gallery Web Page

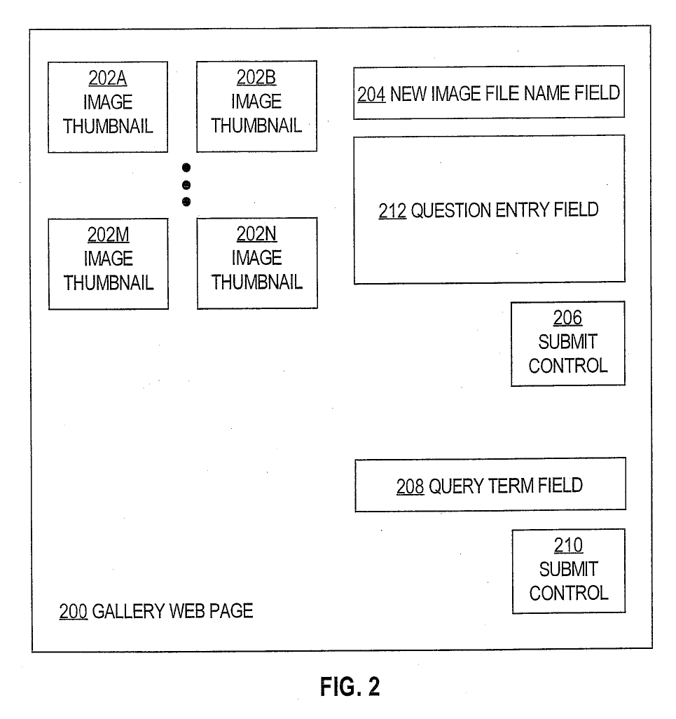

FIG. 2 is a block diagram that illustrates an example of a gallery web page 200 that a server may serve to an Internet browser, according to an embodiment of the invention. In the example illustrated, gallery web page 200 includes image thumbnails 202A-N, a new image file name field 204, a question entry field 212, a query term field 208, and submit controls 206 and 210. Gallery web pages in alternative embodiments of the invention may comprise more, fewer, or different elements than those shown in the example of FIG. 2.

In one embodiment of the invention, when one of browsers 104A-N initially visits the URL that is associated with a web site that server 102 hosts, server 102 dynamically generates gallery web page 200 and returns gallery web page 200 in response to the browser's HTTP request. In one embodiment of the invention, server 102 dynamically re-generates gallery web page 200 after each request for gallery web page 200 from any of browsers 104A-N. In an alternative embodiment of the invention, server 102 dynamically generates gallery web page 200 periodically or in response to some other event that would cause the content of gallery web page 200 to change (e.g., the receipt of a new image) and stores gallery web page 200, serving the stored version of gallery web page 200 in response to incoming requests.

In generating gallery web page 200, server 102 selects a set of images that are stored on a persistent storage device to which server 102 has access. The selected set of images typically will be a smaller subset of the total set of images that are stored on the persistent storage device—images that numerous different users have submitted to server 102 at various times and from various locations. In different embodiments of the invention, server 102 uses different techniques for selecting this subset of images. In one embodiment of the invention, for example, server 102 selects a set of the “N” most recently uploaded images, where “N” is some specified number. In another embodiment of the invention, for example, server 102 selects a set of the “N” uploaded images that are associated with the fewest user-submitted answers and comments, in an effort to glean more answers and comments for those images. In yet other embodiments of the invention, server 102 may use yet other different techniques for selecting the subset of images.

In one embodiment of the invention, for each selected image, server 102 generates a reduced-size thumbnail version of that image. In one embodiment of the invention, server 102 generates and stores a thumbnail version of an image at the time that the image is uploaded to server 102; in such an embodiment of the invention, server 102 does not need to expend effort in generating thumbnail versions at the time that one of browsers 104A-N requests gallery web page 200. Server 102 generates gallery web page 200 in such a manner that image tags referring to the thumbnail versions are laid out in an organized fashion in the source code of gallery web page 200. Additionally, in one embodiment of the invention, server 102 generates gallery web page 200 in such a manner that each image tag also specifies, or is accompanied by, a hypertext link to a process (on server 102) that will dynamically generate an image-specific web page that corresponds to that image tag's thumbnail image. Typically, each such hypertext link refers to the same process, but passes to that process different parameters that refer to the specific image to which the image tag corresponds. As a result, when a user clicks on or otherwise selects one of the thumbnail images that is eventually displayed at one of browsers 104A-N, that browser responsively requests, from server 102, the dynamically generated image-specific web page that server 102 then generates.

In addition to image thumbnails 202A-N, which represent images that various users of browsers 104A-N have uploaded to server 102, gallery web page 200 includes new image file name field 204. In one embodiment of the invention, new image file name field is a Hyptertext Markup Language (HTML) text field into which a viewer of gallery web page 200 can enter the file name and path of an image file that is stored on that viewer's computer. After entering the file name and path of an image file, the user's selection of submit control 206 causes the user's browser to upload, to server 102, the image corresponding to the file name specified in field 204. As is discussed above, in response to receiving an image in this manner, server 102 persistently stores the image. In one embodiment of the invention, after receiving a newly uploaded image, server 102 re-generates gallery web page 200 and sends the re-generated gallery web page 200 to the browser from which the image was received. Depending on the technique that server 102 uses to select the thumbnail versions that are displayed on gallery web page 200, a thumbnail version of the newly uploaded image may appear on the re-generated gallery web page 200. In one embodiment of the invention, the re-generated version of gallery web page 200 that server 102 sends to a browser after that browser has uploaded an image additionally contains an indication, textual or otherwise, that signifies to the browser's user that server 102 successfully received the uploaded image file.

In one embodiment of the invention, before a browser user clicks on or otherwise selects submit control 206 in order to upload a specified image to server 102, that user may enter, into question entry field 212, a question of the user's choosing and creation. For example, the question may be a question that pertains to the identity of the subject of the image that is to be uploaded (e.g., “What is this?”). In one embodiment of the invention, at the time that a user clicks on or otherwise selects submit control 206, that user's browser uploads the contents of question entry field 212 along with the image specified through field 204. When server 102 receives an image that is accompanied by contents of question entry field 212, server 102 additionally stores the contents of question entry field 212 on a persistent storage device, generates a mapping between those contents and the newly uploaded image, and stores the mapping on the persistent storage device for later use.

In one embodiment of the invention, a browser user can enter one or more query terms of the user's own choosing into query term field 208. When the user clicks on or otherwise selects submit control 210, the user's browser sends the query terms to server 102. In response to receiving such query terms, server 102 searches through the questions (e.g., those submitted via question entry field 212) and answers and comments (discussed further below) for questions, answers, and comments that contain or are otherwise relevant to one or more of the submitted query terms. After determining a set of relevant questions, answers, and comments, server 102 dynamically generates a search results page that contains, among potentially other information, thumbnail versions of the images that are associated with those relevant questions, answers, and comments. An example of such a search results page is discussed in greater detail further below.

### Example Image-Specific Page

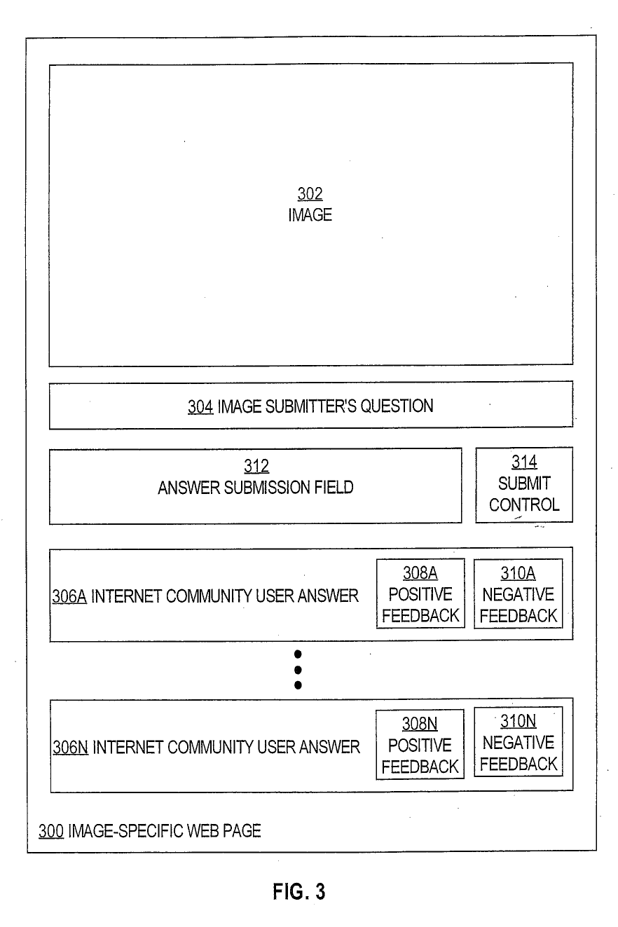

As is discussed above, in one embodiment of the invention, when a user clicks on one of image thumbnails 202A-N, server 102 dynamically generates an image-specific web page corresponding to the image that the clicked-on thumbnail represents. FIG. 3 is a block diagram that illustrates an example of an image-specific web page 300 that a server may serve to an Internet browser, according to an embodiment of the invention. In the example illustrated, image-specific web page 300 includes image 302, image submitter's question 304, internet community user answers 306A-N, positive feedback fields 308A-N, negative feedback fields 310A-N, answer submission field 312, and submit control 314. Image-specific web pages in alternative embodiments of the invention may comprise more, fewer, or different elements than those shown in the example of FIG. 3.

In one embodiment of the invention, image 302 is the full-size image that corresponds to the thumbnail image upon which the user clicked in gallery web page 200. Beneath image 302 is image submitter's question 304. This is the question that the submitter of image 302 submitted along with image 302—although, if the submitter of image 302 did not submit any such question, then the space may be left blank.

Beneath image submitter's question 304 are answer submission field 312 and submit control 314. In one embodiment of the invention, answer submission field 312 is a fillable text box into which the viewer of image-specific web page 300 can enter text that is an answer to question 304 and/or any comment that the viewer would like to make regarding image 302. In such an embodiment of the invention, when the viewer clicks on submit control 314, the viewer's Internet browser sends the contents of answer submission field 312 over Internet 106 to server 102. In response to receiving the contents of field 312, server 102 stores the contents (i.e., the answer and/or comment) on a persistent storage device. Additionally, server 102 creates a mapping between the contents and image 302. Server 102 stores this mapping on the persistent storage device.

Internet community user answers 306A-N each represent answers and/or comments that other users have previously submitted relative to image 302 using an answer submission field as discussed above. In one embodiment of the invention, in generating image-specific web page 300, server 102 retrieves, from the persistent storage device, all of the previously submitted answers and/or comments that are mapped to image 302. Server 102 places these answers and/or comments in image-specific web page 300 before sending image-specific web page 300 to one of browsers 104A-N over Internet 106. Such answers and comments may represent what other users in the Internet user community think about image 302, for example. For example, such answers and comments may attempt to answer question 304 and/or identify the subject of image 302 (whose identity the submitter of image 302 might not have known at the time of submission). In one embodiment of the invention, if no community users have yet submitted answers pertaining to image 302, then web page 300 does not contain answers 306A-N; instead, web page 300 may indicate that no answers or comments pertaining to image 302 have yet been received, and may invite the viewer to be the first to submit such an answer or comment.

In one embodiment of the invention, each of internet community user answers 306A-N is accompanied on image-specific web page 300 by at least two fields: a positive feedback field 308 and a negative feedback field 310. Each of positive feedback fields 308A-N indicates a number of positive responses that the corresponding answer received from users who opted to provide positive feedback relative to that answer. Similarly, each of negative feedback fields 310A-N indicates a number of negative responses that the corresponding answer received from users who opted to provide negative feedback relative to that answer. In one embodiment of the invention, each of positive feedback fields 308A-N is represented as a clickable “thumbs up” icon control, and each of negative feedback fields 310A-N is represented as a clickable “thumbs down” icon control.

In one embodiment of the invention, if the viewer thinks that a particular one of answers 306A-N is a good or appropriate answer (because the answer correctly responds to question 304 or provides useful information), then the viewer may click on the one of positive feedback fields 308A-N that corresponds to that particular answer. In response to the viewer's selection of such a positive feedback field, server 102 increments a positive feedback value that is mapped to the particular answer on the persistent storage device—server 102 uses such positive feedback values to populate positive feedback fields 308A-N while server 102 generates image-specific web page 300. Server 102 additionally may update the value that is displayed in the selected positive feedback field to reflect the increment in that value.

Conversely, in one embodiment of the invention, if the viewer thinks that a particular one of answers 306A-N is a bad or inappropriate answer (because the answer incorrectly responds to question 304 or fails to provide any useful information), then the viewer may click on the one of negative feedback fields 310A-N that corresponds to that particular answer. In response to the viewer's selection of such a negative feedback field, server 102 increments a negative feedback value that is mapped to the particular answer on the persistent storage device—server 102 uses such negative feedback values to populate negative feedback fields 310A-N while server 102 generates image-specific web page 300. Server 102 additionally may update the value that is displayed in the selected negative feedback field to reflect the increment in that value.

Thus, using positive feedback fields 308A-N and negative feedback fields 310A-N, the viewer can register his opinion on the answers that others in the user community have provided relative to image 302. The viewer can use the values shown in these fields in order to gauge the user community's opinion of each of internet community user answers 306A-N.

In one embodiment of the invention, users are permitted to submit answers and comments relative to image 302 only during a specified interval of time that begins when image 302 is initially submitted. In such an embodiment of the invention, answer submission field 312 and submit control 314 are not included within image-specific web page 300 after the time interval has expired.

In one embodiment of the invention, server 102 asks the original submitter of image 302 at some point in time to select, from among internet community user answers 306A-N, one answer that the original submitter thinks is the best of answers 306A-N. When the original submitter selects a best answer, server 302 stores the identity of the best answer on the persistent storage device and stores a mapping between that identity and image 302. In such an embodiment of the invention, if a best answer has been selected by the original submitter, then, when server 102 generates image-specific web page 300, server 102 places, within web page 300, an indication of which of answers 306A-N has been selected by the original submitted of image 302 as the best answer. For example, the best answer may be highlighted within web page 300 and accompanied by text such as “chosen by the image's submitter as the best answer.”

In one embodiment of the invention, for each of answers 306A-N, web page 300 also contains a “flag as offensive” control that a user can activate in order to indicate that the content of the corresponding answer is inappropriate (e.g., obscene, racist, libelous, illegal, etc.). In response to receiving an indication that a particular answer is offensive, server 102 may suppress the answer by refraining to include the answer in subsequently generated editions of web page 300. The answer flagged as offensive may be reviewed by the operator of a web site that is hosted by server 102, and, if the flagged answer is not actually offensive, then the operator may remove the “offensive” flag from the answer so that the answer re-appears in subsequently generated editions of web page 300.

### Example Search Results Page

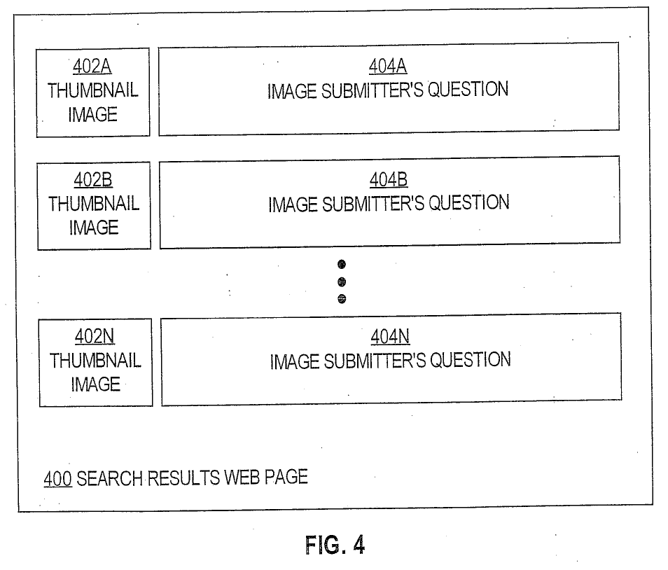

As is discussed above, in one embodiment of the invention, when a user enters query terms into query term field 208 and clicks on submit control 210, server 102 dynamically generates a search results web page that contains images that are associated with user-submitted answers or comments that contain or are otherwise relevant to one or more of those query terms. FIG. 4 is a block diagram that illustrates an example of a search results web page 400 that a server may serve to an Internet browser, according to an embodiment of the invention. In the example illustrated, search results web page 400 includes thumbnail images 402A-N and image submitter's questions 404A-N. Search results web pages in alternative embodiments of the invention may comprise more, fewer, or different elements than those shown in the example of FIG. 4.

In one embodiment of the invention, for each question or answer that contains one or more of the submitted query terms, server 102 places, on search results web page 400, that question or answer (or a portion thereof) along with a thumbnail version of the image to which that question or answer is mapped. These questions or answers and thumbnail images are shown in FIG. 4 as thumbnail images 402A-N and image submitter's questions 404A-N. Additionally, in one embodiment of the invention, for each of thumbnail images 402A-N, server 102 places, into web page 400, an indication of how many answers have been received from community users for the corresponding image. Additionally, in one embodiment of the invention, for each of thumbnail images 402A-N, server 102 places, into web page 400, the identity of the community user that originally submitted the corresponding image. In one embodiment of the invention, within each of questions 404A-N (which may, additionally, or alternatively, be answers or comments), server 102 highlights the query terms that occur within that question (or answer or comment).

In one embodiment of the invention, when the viewer of search results web page 400 clicks on one of thumbnail images 402A-N, server 102 sends, over Internet 106, to the viewer's browser, the image-specific web page that corresponds to the image whose thumbnail version the viewer selected. Image-specific web pages are discussed above with reference to FIG. 3.

Beneficially, the images returned as search results typically will be images that are actually related to the query terms rather than images that are merely within pages that might be related to the query terms. This is in large part due to the fact that the questions, answers, and comments that are searched for the query terms usually will constitute text that was specifically provided by a member of a user community to describe an image.

### Community Response Notifications

In one embodiment of the invention, when a user uploads an image to server 102, the user specifies (e.g., through a field in a web page provided by server 102) whether or not and how the user would like to be notified if and when an answer or comment is received in relation to that image. For example, the user may specify that the user would like to receive a text message on the user's cellular telephone every time that any other user submits an answer or comment (e.g., through image-specific web page 300) that pertains to the user's uploaded image. For another example, the user may specify that the user would like to receive such a text message only after the first answer or comment pertaining the image has been submitted.

In one embodiment of the invention, if the user indicates, to server 102, that the user would like to be so notified about other user's responses to the image, then server 102 stores data that indicates this fact. Subsequently, whenever any other user submits a comment or answer relative to the image, server 102 checks the stored notification preferences of the user that uploaded the image, and may send a notification, in the specified manner, to the user who uploaded the image. For example, server 102 may send, to the cellular telephone or e-mail client application of the user who uploaded the image, a message that indicates that a new comment or answer has been submitted for the image. In one embodiment of the invention, the message also contains the content of the new comment or answer that was submitted for the image.

In one embodiment of the invention, the user who uploads the image additionally specifies, to server 102 (e.g., via a fillable field in a web page form), times of day during which the user does not want to receive notifications of submissions of answers or comments that pertain to the user's uploaded image. In such an embodiment of the invention, if the user has specified such times of day (e.g., between midnight and 8:00 AM), then server 102 refrains from sending text messages to the user during the specified times. Instead, server 102 may wait until after the specified times have passed, and then send the text messages to the user's device.

### Image Categories

In one embodiment of the invention, in addition to submitting an image and, potentially, a question to server 102, a user also selects a category into which the user thinks the image might belong. For example, the user might select a category from a set or tree of categories that server 102 presents to the user in the form of a web page. In response to receiving the indication of a category from a user, server 102 stores the identity of that category in association with the uploaded image.

In one embodiment of the invention, when another user enters query terms in order to search for images whose associated questions and answers contain those query terms, the user may also optionally submit one or more image categories in which the user wants to search. Under such circumstances, the server limits the search and search results to images that have been associated with the selected categories, rather than all uploaded images generally.

Additionally, in one embodiment of the invention, server 102 attempts to categorize uploaded images automatically, even without any category selection from a user. For example, in one embodiment of the invention, when server 102 receives an uploaded image from a cellular telephone, server 102 also receives, from that cellular telephone, an indication of the geographical location of the cellular telephone at the time that the image was taken by the cellular telephone's built-in camera. The cellular telephone may be able to provide this information using global positioning system data received from a satellite, for example. In response to receiving a geographical location indication from a cellular telephone in association with an uploaded image, server 102 determines a set of categories that are associated with that geographical location. For example, in a database, the geographical location “Yosemite National Park, California, U.S.A.” may be associated with a “nature” category, among possibly other categories. Therefore, server 102 may store, with the uploaded image (e.g., a digital photograph of Half Dome), a mapping between the image and the “nature” category. This may be the case even though the user who uploaded the image did not specify “nature” as one of the categories to which the image belonged.

### Hardware Overview

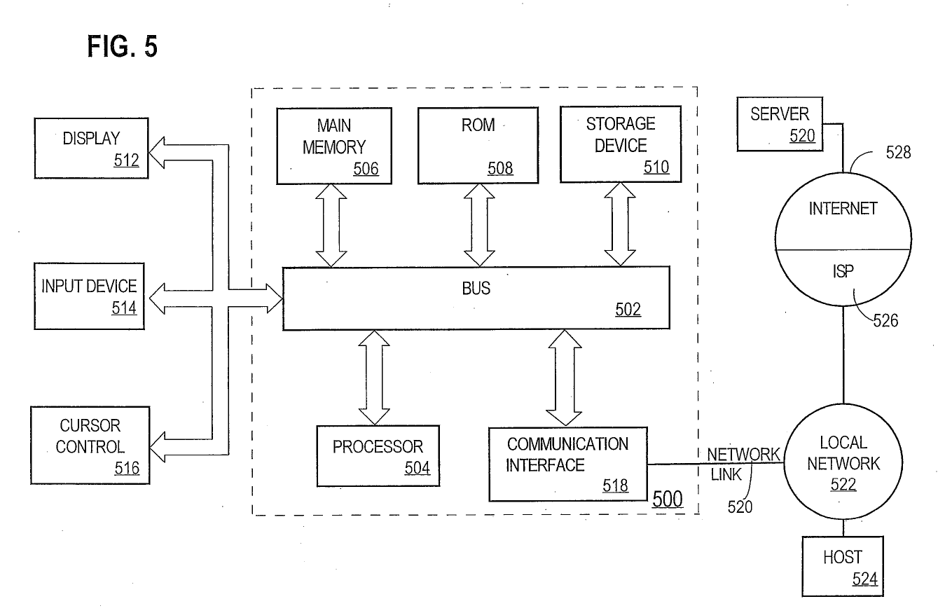

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to storage media and transmission media. Storage media includes both non-volatile media and volatile media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 550 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
receiving, over a network, an image that was uploaded by a first user;
sending the image over the network to a second user who differs from the first user;
receiving, over the network, from the second user, particular text that pertains to the image;
storing the particular text in association with the image on a persistent storage device; and
sending, to a third user, over the network, data that contains both the image and the particular text.

2. The method of claim 1, further comprising:
receiving, over the network, from the third user, one or more query terms;
searching the persistent storage device for text that contains one or more of the one or more query terms;
determining that the particular text contains one or more of the one or more query terms;
determining that the particular text is associated with the image; and
in response to determining that the particular text contains one or more of the one of more query terms and that the particular text is associated with the image, sending the data to the third user over the network.

3. The method of claim 1, further comprising:
receiving, over the network, from the first user, a question that pertains to the image;
storing the question in association with the image on the persistent storage device; and
sending the question with the image over the network to the second user;
wherein the particular text received from the second user is an answer to the question.

4. The method of claim 1, further comprising:
receiving, over the network, from the third user, feedback that pertains to the particular text;
storing the feedback on the persistent storage device in association with the particular text; and
sending the feedback with the particular text and the image over the network to a fourth user.

5. The method of claim 1, further comprising:
receiving, over the network, from the first user, a question that pertains to the image;
storing the question in association with the image on the persistent storage device;
sending the question with the image over the network to the second user;
receiving, over the network, from the third user, one or more query terms;
searching the persistent storage device for text that contains one or more of the one or more query terms;
determining that the question contains one or more of the one or more query terms;
determining that the question is associated with the image; and
in response to determining that the question contains one or more of the one of more query terms and that the particular question is associated with the image, sending the data to the third user over the network.

6. The method of claim 1, further comprising:
sending, to the second user, a gallery of two or more thumbnail images that include a thumbnail version of the image received from the first user;
wherein at least one of the two or more thumbnail images corresponds to an image that is not yet associated with any text received from the first user and that is not yet associated with any text received from the second user.

7. The method of claim 1, further comprising:
receiving, over the network, from the third user, one or more query terms;
searching the persistent storage device for text that contains one or more of the one or more query terms; and
sending, to the third user, over the network, (a) a set of thumbnail versions of images that are each associated with user-submitted question answers that contain at least one of the one or more query terms and (b) for each thumbnail version in the set of thumbnail versions, at least a portion of a user-submitted question answer that is associated with the image that said thumbnail version represents.

8. The method of claim 1, further comprising:
sending, over the network, to the second user, along with the image, (a) a set of comments that other users previously have submitted related to the image, and (b) for each comment in the set of comments, both a positive feedback value and a negative feedback value that are both based on feedback received from other users who viewed that comment.

9. The method of claim 1, further comprising:
sending, over the network, to the second user, along with the image, (a) a set of comments that other users previously have submitted related to the image, and (b) information that indicates which one of the comments was selected by the user as being as best of the comments.

10. The method of claim 1, further comprising:
in response to receiving the particular text from the second user, sending, to a cellular telephone of the first user, a notification that indicates that a user has submitted a comment pertaining to the image.

11. A volatile or non-volatile computer-readable storage medium carrying one or more sequences of instructions which, when executed by one or more processors, cause the one or more processors to perform the steps recited in claim 1.

12. A volatile or non-volatile computer-readable storage medium carrying one or more sequences of instructions which, when executed by one or more processors, cause the one or more processors to perform the steps recited in claim 2.

13. A volatile or non-volatile computer-readable storage medium carrying one or more sequences of instructions which, when executed by one or more processors, cause the one or more processors to perform the steps recited in claim 3.

14. A volatile or non-volatile computer-readable storage medium carrying one or more sequences of instructions which, when executed by one or more processors, cause the one or more processors to perform the steps recited in claim 4.

15. A volatile or non-volatile computer-readable storage medium carrying one or more sequences of instructions which, when executed by one or more processors, cause the one or more processors to perform the steps recited in claim 5.

16. A volatile or non-volatile computer-readable storage medium carrying one or more sequences of instructions which, when executed by one or more processors, cause the one or more processors to perform the steps recited in claim 6.

17. A volatile or non-volatile computer-readable storage medium carrying one or more sequences of instructions which, when executed by one or more processors, cause the one or more processors to perform the steps recited in claim 7.

18. A volatile or non-volatile computer-readable storage medium carrying one or more sequences of instructions which, when executed by one or more processors, cause the one or more processors to perform the steps recited in claim 8.

19. A volatile or non-volatile computer-readable storage medium carrying one or more sequences of instructions which, when executed by one or more processors, cause the one or more processors to perform the steps recited in claim 9.

20. A volatile or non-volatile computer-readable storage medium carrying one or more sequences of instructions which, when executed by one or more processors, cause the one or more processors to perform the steps recited in claim 10.
